(19) United States
(12) Patent Application Publication
(10) Pub. No.: US 2026/0239032 A1
(43) Pub. Date: Aug. 13, 2026

(54) CONNECTIVITY LOSS DETECTION AND REASSOCIATION

(71) Applicant: Nokia Technologies Oy, Espoo (FI)

(72) Inventors: Navin HATHIRAMANI, Coppell, TX (US); Yonggang WANG, Shanghai (CN); Ahlem KHLASS, Massy (FR); Muhammad Majid BUTT, Naperville, IL (US)

(21) Appl. No.: 19/157,459

(22) PCT Filed: Mar. 10, 2023
(86) PCT No.: PCT/CN2023/080698

§ 371 Date: Aug. 18, 2025

(51) Int. Cl. H04W 24/02; H04B 17/336; H04W 24/10

(52) U.S. Cl. CPC H04W 24/02; H04B 17/336; H04W 24/10

(57) ABSTRACT

Example embodiments of the present disclosure relate to devices, methods, apparatuses and computer readable storage medium for connectivity loss detection and reassociation. In a method, a network device transmits, to a set of devices, a first configuration including a first set of duty cycles for querying a plurality of terminal devices associated with the set of devices. The network device receives, from the set of devices, a set of measurement reports for the plurality of terminal devices.

### FIELDS

Various example embodiments of the present disclosure generally relate to the field of telecommunication and in particular, to devices, methods, apparatuses and computer readable storage medium for connectivity loss detection and reassociation.

### BACKGROUND

With energy harvesting technology, a device may harvest energy present in an ambient environment. This may allow the device to use the harvested energy and operate in a passive mode. Ambient internet of things (IoTs) refer to energy harvesting enabled communication services and have been widely used in various vertical industries. A tag is a typical example of Ambient (also called Passive IoT (PIoT)) devices and may have limited capabilities. The tag may be connected or associated with the network through a reader. Tags and/or readers may not always be statically located at one position or location. Due to reader and/or tag mobility, the tags may lose their connectivity with the network.

### SUMMARY

In a first aspect of the present disclosure, there is provided a network device. The network device comprises at least one processor; and at least one memory storing instructions that, when executed by the at least one processor, cause the network device at least to perform: transmitting, to a set of devices, a first configuration including a first set of duty cycles for querying a plurality of terminal devices associated with the set of devices; and receiving, from the set of devices, a set of measurement reports for the plurality of terminal devices.

In a second aspect of the present disclosure, there is provided a device. The second device comprises at least one processor; and at least one memory storing instructions that, when executed by the at least one processor, cause the device at least to perform: receiving, from a network device, a first configuration including a first duty cycle for querying a terminal device; transmitting, to the terminal device, a query using the first duty cycle; determining, a measured power level of a signal backscattered by the terminal device as a response to the query; and transmitting, to the network device, based on the measured power level of the backscattered signal, a measurement report for the terminal device.

In a third aspect of the present disclosure, there is provided a method. The method comprises: transmitting, to a set of devices, a first configuration including a first set of duty cycles for querying a plurality of terminal devices associated with the set of devices; and receiving, from the set of devices, a set of measurement reports for the plurality of terminal devices.

In a fourth aspect of the present disclosure, there is provided a method. The method comprises: receiving, from a network device, a first configuration including a first duty cycle for querying a terminal device; transmitting, to the terminal device, a query using the first duty cycle; determining, a measured power level of a signal backscattered by the terminal device as a response to the query; and transmitting, to the network device, based on the measured power level of the backscattered signal, a measurement report for the terminal device.

In a fifth aspect of the present disclosure, there is provided an apparatus. The apparatus comprises means for transmitting, to a set of devices, a first configuration including a first set of duty cycles for querying a plurality of terminal devices associated with the set of devices; and means for receiving, from the set of devices, a set of measurement reports for the plurality of terminal devices.

In a sixth aspect of the present disclosure, there is provided an apparatus. The apparatus comprises means for receiving, from a network device, a first configuration including a first duty cycle for querying a terminal device; means for transmitting, to the terminal device, a query using the first duty cycle; means for determining, a measured power level of a signal backscattered by the terminal device as a response to the query; and means for transmitting, to the network device, based on the measured power level of the backscattered signal, a measurement report for the terminal device.

In a seventh aspect of the present disclosure, there is provided a computer readable medium. The computer readable medium comprises instructions stored thereon for causing an apparatus to perform at least the method according to the third aspect.

In an eighth aspect of the present disclosure, there is provided a computer readable medium. The computer readable medium comprises instructions stored thereon for causing an apparatus to perform at least the method according to the fourth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates a high-level signaling diagram of a process for connectivity loss detection according to some example embodiments of the present disclosure;

FIG. 3 illustrates a flowchart of an example method for connectivity detection in accordance with some example embodiments of the present disclosure;

FIG. 4 illustrates an example configuration of query frequencies for a terminal device according to some example embodiments of the present disclosure;

FIG. 5 illustrates a flowchart of an example process for connectivity detection and reassociation in accordance with some example embodiments of the present disclosure;

FIG. 6 illustrates a flowchart of an example method for connectivity detection in accordance with some example embodiments of the present disclosure;

FIG. 7 illustrates a flowchart of an example process for connectivity detection in accordance with some example embodiments of the present disclosure;

FIG. 8 illustrates a signaling diagram of a process for connectivity detection and reassociation according to some example embodiments of the present disclosure;

FIG. 9 illustrates a simplified block diagram of a device that is suitable for implementing example embodiments of the present disclosure; and

FIG. 10 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an New Radio (NR) NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

In some example embodiments, the terminal device may comprise an Ambient/passive IoT device such as a tag. The Passive IoT device may harvest energy from both the third Generation Partnership Project (3GPP) and non-3GPP devices. For example, the passive IoT device may be illuminated by energy signals and backscatter information to a device (such as a reader) capable of receiving and processing a signal backscattered by a passive IoT such as a tag.

A device (such as a passive IoT device), powered by energy harvesting, may also be referred to as an energy harvesting device, may use an energy harvested from radio waves or any other form of energy that may be harvested in its (particular) deployment scenario. If an energy is harvested from radio waves, an output power of an energy harvester may be from several micro-watt to tens of micro-watt. If a solar panel is used for energy harvesting from solar and/or light, the output power of the energy harvester may be less than 1 milli-watt due to a small size of the solar panel.

Some energy harvesting devices may possess an active transmission circuitry. After harvesting the energy, such an energy harvesting device may use this active circuit for transmission, similar to a conventional transmitter. Some other energy harvesting devices, also referred to a passive device, may not possess an active transmission circuitry and backscatter a signal in a passive mode.

Passive IoT services have been widely used in various vertical industries including logistics, manufacture, transportation, energy industry, and/or the like. Enabling passive IoT devices in both public and private networks may benefit the 5G or even 6G ecosystem. Passive IoT may be applied in the following scenarios: 1) a scenario where a device operates under extreme environmental conditions such as a high pressure, an extremely high or low temperature, a humid environment, vibration, and/or the like; 2) a scenario where ultra-low complexity (or cost), a very small terminal size (or form) factor (for example, thickness of mm), a maintenance-free and longer life cycle and/or the like are required; 3) other scenarios where a device driven by a battery is not applicable. Therefore, it may be required to support passive IoT using either a battery-less device or a device with a limited energy storage capability (for example, using a capacitor).

For Passive IoT, radio frequency identification (RFID) solutions together with the backscattering technology may be used, also called backscattering RFID solutions. An objective of passive IoT is to use 3GPP technologies to enhance coverage for the backscattering RFID solutions as well as introducing new solutions with advanced features such as harvesting an energy from a dedicated source or an ambient energy source and spending the energy efficiently for IoT-type of data transmissions. Some relevant use cases, traffic scenarios and key performance indicators (KPIs) may be defined in 3GPP. The considered devices cover both the battery-less type of devices or devices with limited energy storage capabilities, and the energy may be provided via radio wave harvesting, light, motion, and/or the like.

For passive IoT or ambient energy enabled IoT with energy harvesting capabilities, low rate and low complexity may be targeted, and both battery-less devices and devices with small batteries may need to be supported. Moreover, both active and passive IoT devices may need to be supported. Radio Access Network (RAN) design targets may be based on the identified deployment scenarios and their characteristics for the relevant use cases, which may include power consumption, complexity, coverage, data rates, and positioning accuracy, for example.

In some scenarios, tags and/or readers may not be always statically located at one position or location. Due to reader and/or tag mobility, the tags may lose their connectivity with a network. As “make before break” functionality may not be required for such low-end devices which may support use cases such as warehouse inventory management, there may be no need to allocate resources in advance and develop mechanisms to maintain connectivity and service continuity, as for legacy New Radio (NR) devices.

Thus, there may be some tag association challenges. For example, it may be difficult for a tag to be aware of a lost connection with the originally associated reader. Meanwhile, it may be difficult for a reader to know that the tag is out of its coverage and when a reassociation or reattachment process needs to be started.

Example embodiments of the present disclosure propose a scheme for connectivity loss detection. This scheme allows a device (such as a reader), which may be connected to a set of terminal devices (such as tags) and capable of illuminating or sending excitation signals to the set of terminal devices, to proactively detect a loss of a connection with the terminal device and to inform a network to start a re-connectivity procedure with the terminal device. With this scheme, a network device (such as a gNB) transmits, to a set of devices associated with a plurality of terminal devices, a configuration including a set of duty cycles (also called query duty cycles) for querying the terminal devices. The set of devices use the duty cycles to query the associated terminal devices and transmits, to the network device, measurement reports for the terminal devices which may be generated based on responses from the terminal devices for the queries.

Using a configuration of querying duty cycles, a plurality of readers may proactively query a particular tag and report measured signal powers for the tag and/or information on missing tags. Based on such reporting, the network may reassociate the tag with different readers without a loss of connectivity. Thus, events of a connectivity loss may be reduced between a tag and a set of readers, and reader and/or tag mobility may be enabled.

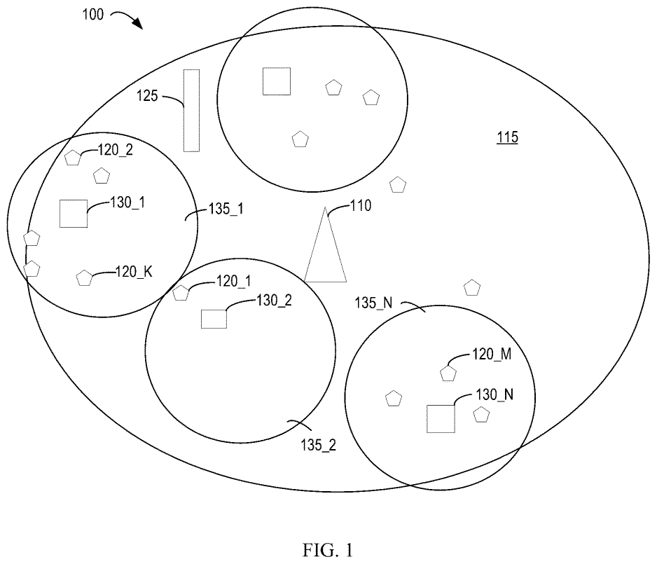

FIG. 1 illustrates an example communication environment 100 in which example embodiments of the present disclosure can be implemented. In the communication environment 100, a network device 110 serves a coverage area 115. Examples of the network device 110 may comprise a base station in a cellular network, and the coverage area 115 may be a cell served by the base station. Alternatively, the network device 110 may operate as an access point or other network devices.

A plurality of terminal devices 120_1, . . . , 120_K, . . . , 120_M (individually or collectively referred to as a terminal device 120) are located in the coverage area 115, where K and M represent positive integers and K<M. In an example, the terminal devices 120 may be capable of harvesting ambient energy from different energy sources, such as mechanical vibrations, electromagnetic sources, light, acoustic, airflow, heat, temperature variations, and/or the like, and converting the ambient energy into usable electrical energy. For example, terminal devices 120 may harvest energy from an electromagnetic energy source 125 which may be either a 3GPP or non-3GPP ambient energy source.

Examples of the terminal devices 120 may comprise a device with a limited capability such as a tag or a RFID tag or a wireless device (for example, a sensor) with a tag. The terminal device 120 may be provided with a transceiver (or a receiver and a transmitter) to receive and transmit (or backscatter) a signal and with or without a power source (for example, in the form of a battery). Alternatively, or in addition, the terminal devices 120 may operate as a slightly smarter device with a microprocessor which may have the capability of performing some limited processing after receiving a signal and/or prior to transmitting a signal. The terminal devices 120 may operate as other more intelligent wireless devices such as a smarter IoT device. For the purpose of discussion, some example embodiments will be discussed by taking tags as an example of the terminal devices 120.

The communication environment 100 may further include devices 130_1, 130_2, . . . , 130_N (individually or collectively referred to as a device 130) which provide corresponding coverage areas 135_1, . . . , 135_N (individually or collectively referred to as a coverage area 135), where N represents a positive integer. The devices 130 may communicate with both the network device 110 and the terminal devices 120 within their coverage areas 135. For example, the device 130_1 may serve the coverage area 135_1 and be associated with the terminal devices 120_1, 120_2, . . . , 120_K within its served coverage area 135_1.

The device 130 may be any device that is capable of illuminating signals and decoding signals backscattered by the terminal device 120. Examples of the devices 130 may comprise a reader or a RFID reader which may receive a signal transmitted (or backscattered) by the associated terminal device 120. The device 130 may be provided in a monostatic or bistatic configuration. In the monostatic configuration, the device 130 (for example, a reader) may both illuminate and receive signals. In the bistatic configuration, the device 130 may include two distributed units or modules (for example, an illuminator/excitor and a reader), one for signal illumination and the other for signal reception. Thus, a terminal device 120 may be connected or associated with the network through a particular device 130 such as a reader (in the monostatic configuration) or a pair of an illuminator and a reader (in the bistatic configuration). Although some example embodiments are discussed in a monostatic scenario, these embodiments are also applicable to a bistatic scenario.

The devices 130 may operate as other wireless devices for the signal illumination and reception, which may include a terminal device such as a UE and a network device such as a base station. For the purpose of discussion, some example embodiments will be discussed by taking readers as an example of the devices 130.

It is to be understood that the numbers of devices are shown in FIG. 1 only for the purpose of illustration without suggesting any limitations. The communication environment 100 may include any suitable number of network devices 110, terminal devices 120 and associated (or attached) devices 130. Any suitable number of terminal devices 120 and the associated devices 130 may be located in the coverage area 115 of the network device 110, and any suitable number of terminal devices 120 may be located in a coverage area 135 of a device 130.

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM), RFID, and/or any other technologies currently known or to be developed in the future.

In the environment 100, the terminal device 120_1 may be originally associated with (or connected or attached to) the device 130_1 which may maintain a list of terminal devices 120_1, 120_2, . . . , 120_K associated with or connected to it. The connectivity may be maintained for a configured time T. If a terminal device 120_1, 120_2, . . . , 120_K does not transmit any data during this time T, connectivity information may be terminated. In this case, association procedures may be performed between the terminal devices 120_1, 120_2, . . . , 120_K and the device 130_1. However, during this time T, connectivity between the terminal devices 120_1, 120_2, . . . , 120_K and the device 130_1 may need to be maintained such that the terminal devices 120_1, 120_2, . . . , 120_K may be able to communicate whenever they have data to transmit.

In some scenarios, the terminal devices 120 and/or the device 130 may not be statically located at one position. Due to the mobility of the terminal devices 120 and/or the device 130, the terminal devices 120 may lose their connectivity with the network. For example, as shown in FIG. 1, the terminal device 120_1 is moving out of the coverage area 135_1 of the device 130_1 and towards the coverage area 135_2 of the device 130_2. Thus, the terminal device 120_1 may lose a connection with the network. As the terminal device 120_1 may be limited in its capabilities, the network (for example, the network device 110) and the associated device 130_1 may be primed with connectivity loss detection.

In some example embodiments, the network device 110 may set a duty cycle for querying each terminal device 120. The devices 130 may employ the duty cycles to query the terminal devices 120 and report, to the network device 110, received powers for the terminal devices 120 and/or information on missing terminal devices.

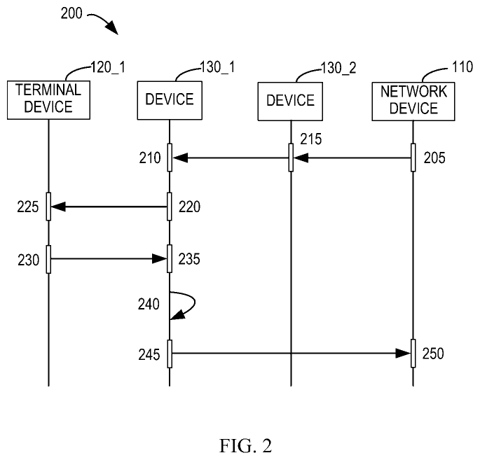

FIG. 2 shows a high-level signaling diagram of a process 200 for connectivity loss detection according to some example embodiments of the present disclosure. For the purpose of discussion, the process 200 will be described with reference to FIG. 1.

In the process 200, the network device 110 may transmit (205), to a set of devices 130_1, 130_2, . . . , 130_N, a first configuration including a first set of duty cycles for querying a plurality of associated terminal devices 120, for example, including the terminal device 120_1. In this example, as the terminal device 120_1 is moving out of the coverage area 135_1 of the device 130_1 towards device 130_2, the terminal device 120_1 is associated with both the devices 130_1 and 130_2. In an example, the duty cycles for the terminal device 120_1 may be set by the network device 110 such that the devices 130_1 and 130_2 associated with the terminal device 120_1 may not query the terminal device 120_1 at the same time.

As shown in FIG. 2, the devices 130_1 and 130_2 may receive (210, 215) the first configuration. Then, the devices 130_1 and 130_2 may employ the duty cycles associated with the terminal device 120_1 to query the terminal device 120_1. As an example, the device 130_1 may transmit (220) a query to the terminal device 120_1 using a first duty cycle configured by the network device 110 for the terminal device 120_1. After the terminal device 120_1 receives (225) the query, the terminal device 120_1 may backscatter (230) a signal to the device 130_1 as a response to the query.

Herein, the query which is performed by the devices 130 may not be a specific command, but just used to evaluate connectivity between the devices and the associated terminal devices 120. The query may refer to any interaction the device 130 may have with a single terminal device 130 (unicast), including, for example, a normal inquiry procedure from the device 130 to retrieve some data from the terminal device 120.

After the device 130_1 receives (235) the signal from the terminal device 120_1 as a response of the query, the device 130_1 may determine (240) a measured power level of the signal. The measured power level may be obtained based on a received signal power, signal and interference to noise ratio (SINR), and/or other received signal strength indications. Based on measured power level of the signal, the device 130_1 may transmit (245) a measurement report for the terminal device 120_1 to the network device 110.

Due to the mobility of the terminal device 120_1 towards the device 130_2, the device 130_1 may not receive a response from the terminal device 120_1, or the measured power level of the signal from the terminal device 120_1 may be lower. In this case, the measurement report from the device 130_1 may report a loss of a connection with the terminal device 120_1. Based on such reporting, after receiving (250) the measurement report for the terminal device 120_1, the network device 110 may reconfigure duty cycles for each device 130 or initiate a re-association process for the terminal device 120_1.

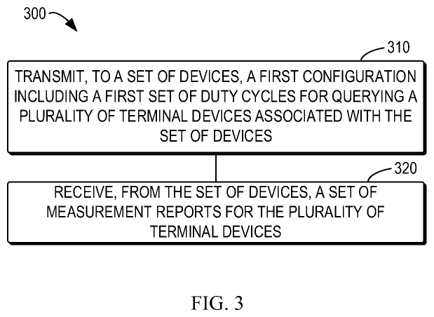

Some example implementations at the network device 110 will be discussed below with reference to FIGS. 3 to 5.

FIG. 3 shows a flowchart of an example method 300 for connectivity detection in accordance with some example embodiments of the present disclosure. The method 300 may be implemented at the network device 110. For the purpose of discussion, the method 300 will be described from the perspective of the network device 110 with reference to FIG. 1.

At block 310, the network device 110 transmits, to a set of devices 130_1, 130_2, . . . , 130_N, a first configuration including a first set of duty cycles for querying a plurality of terminal devices 120 associated with these devices. In some example embodiments, the first configuration may be an original configuration for duty cycles that is provided to the devices 130 during association procedures. Each device 130 may be associated with a different set of terminal devices 120 while some of the terminal devices 120 may be associated with more than one device 130.

In some example embodiments, the first set of duty cycles may be configured to avoid more than one query transmitted to a terminal device 120 at a query occasion. For example, the network device 110 may configure each device 120 with a specific duty cycle. Thus, time diversity may be achieved in querying the same terminal device 120, thereby avoiding query conflict and further improving the connectivity detection efficiency.

In some example embodiments, frequencies for querying a terminal device 120 may be determined based on a proximity between the set of devices 130 and the terminal device 120. In an example, for a terminal device 120 associated with more than one device 130, the query frequencies of the devices 130 may be configured based on the measured power level (such as SINR measurements) of the signal backscattered from the tag, reported by the devices 130. For example, the closest device 130 to a terminal device 120 may have the highest querying frequency, thereby further improving query efficiency.

The proximity between the set of devices 130 and the terminal device 120 may be determined based on a power level of signals measured by the set of devices 130 for the terminal device 120. In an example, the closeness between the devices 130 and the terminal device 120 may be identified during an association process of the terminal device 120 based on measurements of a signal received power performed and reported by the devices 130.

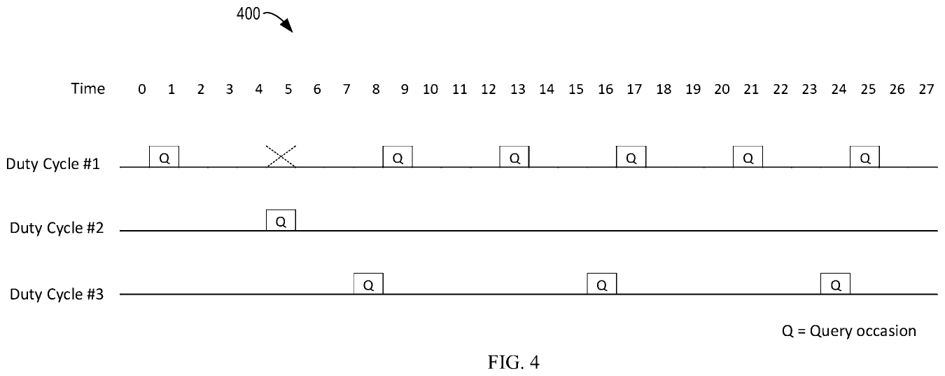

An example of a configuration for the query frequencies will be discussed below with reference to FIG. 4.

FIG. 4 shows an example configuration 400 of query frequencies for a terminal device 120 according to some example embodiments of the present disclosure.

In this example, three devices 130 (referred to as a first device, a second device and a third device, respectively) are associated with a single terminal device 120. The first device may have reported the highest SINR of the signal backscattered from the terminal device 120, followed by the third device and then the second device. Based on this, the first device is configured with Duty Cycle #1 to query the terminal device 120 every 4 units of time, the third device is configured with Duty Cycle #3 to query the terminal device 120 every 8 units of time, and the second device is configured with Duty Cycle #2 to be restricted to one query every 30 units of time.

In an example, as shown in FIG. 4, the first device may skip a query opportunity at a time 7 to allow for a query of the second device to further avoid conflicts. Duty Cycle #1 and Duty Cycle #3 are orthogonal, and hence no additional query occasions need to be skipped by the first device for the third device. Other approaches for diversifying the query cycles may be possible.

Still with reference to FIG. 3, at block 320, the network device 110 receives, from the set of devices 130_1, 130_2, . . . , 130_N, a set of measurement reports for the plurality of terminal devices 120. The reports may be received periodically or triggered by an event, which may depend on a configuration of the network or the network device 110. In some example embodiments, a report of the measurement reports may comprise at least one identification (ID) of at least one terminal device of the plurality of terminal devices and at least one measured power level of a signal backscattered by the at least one terminal device.

The measurement reports may comprise a report of a loss of a connection with a terminal device 120. In some example embodiments, the network device 110 may configure a first condition to be used for identifying a loss of a connection with a terminal device of the plurality of terminal devices and transmit, to the set of devices 130_1, 130_2, . . . , 130_N, a configuration including the first condition. The first condition may involve any factor or parameter that is related to a connectivity or mobility state of the device 130 and the terminal device 120.

In an example, the first condition may be based on a comparison of a measured power level of signals backscattered by the terminal device with a power level threshold. The power level threshold may be configured by the network device 110. For example, the network device 110 may transmit, to the set of devices 130_1, 130_2, . . . , 130_N, a configuration including a power level threshold to be used for identifying a loss of a connection with a terminal device of the plurality of terminal devices.

The power level threshold may comprise a minimum power or energy threshold to declare a terminal device 120 as lost. In an example, the minimum power threshold may indicate a minimum power that the received power of the backscattered signals needs to reach, or a minimum SINR of the backscattered signals.

In addition, the first condition may consider the first number of signals backscattered by the terminal device and the second number of queries to the terminal device. For example, the first condition may be satisfied when a measured power level of a first number of signals backscattered by the terminal device as a response to a second number of queries to the terminal device is less than or equal to the power level threshold. As an example, the first condition may require detecting X number of queries for which the measured power level of the signal backscattered by the terminal device is below the minimum threshold configured, out Y attempted queries. X and Y represent positive integers. The values of X and Y may be configured as the first configuration in an association procedure.

In some example embodiments, the network device 110 may transmit, to the set of devices 130_1, 130_2, . . . , 130_N, a configuration including a set of power levels to be used for transmissions of queries towards the plurality of terminal devices. This configuration may be transmitted during an association procedure. The power level may comprise the maximum allowed power level for transmissions towards a terminal device.

In some example embodiments, the network device 110 may use measurement results (including the measured power level or a loss event) in the measurement report to fine tune a power level threshold (for example, the minimum configured power threshold) to be used for identifying a loss of a connection with a specific terminal device or a power level (for example, the maximum transmission power) to be used for transmissions towards a specific terminal device.

In some example embodiments, based on the received measurement reports (periodic or event based), the network device 110 may transmit, to a subset of the set of devices 130_1, 130_2, . . . , 130_N, a second configuration including a second set of duty cycles for querying the terminal devices 120. Thus, the network device 110 may dynamically reconfigure query duty cycles to be used by the individual devices 130. It is to be understood that although the first configuration and the second configuration as mentioned above and other configurations as mentioned below are discussed separately, some or even all of these configurations may be integrated or contained in one configuration.

After receiving, from a device 130, a report of a loss of a connection with a terminal device 120, the network device 110 may determine whether at least one further device 130 in the set of devices 130_1, 130_2, . . . , 130 N is associated with the terminal device 120, for example, whether the terminal device 120 has been configured with a connection to any other device 130. If so, the network device 110 may transmit, to the at least one further device a third configuration including at least one duty cycle for querying the terminal device 120. The third configuration may be a part of the second configuration. As such, the reconfiguration of the duty cycles may be more effective and efficient.

In some example embodiments, this reconfiguration may be triggered based on a second condition for enabling a reconfiguration of a duty cycle. The setting of the second condition may consider any factor or parameter to facilitate the re-establishment of a connection between the device 130 and the terminal device 120.

In an example, the second condition may be based on the frequencies of the duty cycles, for example, a comparison of values of the frequencies with a threshold value. For example, the second condition may be satisfied when a frequency of a first number of duty cycles used by the at least one further device for querying the first number of terminal devices is equal to or lower than the threshold frequency. The threshold value may be set depending on the implementations. Considering that the terminal device may benefit from more frequent query duty cycles, a relatively lower frequency of the duty cycles may be suboptimal. If the query duty cycles configured for the at least one further device has a lower querying frequency, or a suboptimal frequency, the reconfiguration may be enabled.

In the context of the present disclosure, a suboptimal querying frequency refers to a querying frequency which is not fully aligned with the ideal frequency of retrieval of data from the terminal devices. For example, after a terminal device 120 has lost connectivity with a device 130, its query frequency may be, for example, once every 30 seconds from the remaining devices associated with the terminal device 120. If data retrieval from the terminal device 120 require data every 10 seconds during a specific period of time, then the network device 110 may recognize this suboptimal configuration based on assistance information from some higher layer entities and perform a reconfiguration.

The determining of the suboptimal frequency may take network loads or other network states into account. For example, data retrieval at a frequency of 30 seconds may be not allowed during high load working hours in an industrial environment, but acceptable during low working hours. Hence, in the low working hours, the network device 110 may wait until several reconfigurations are required for a specific device 130 to reduce the control-plane (c-plane) load in the network.

In addition to the frequencies of the duty cycles, the second condition for enabling a reconfiguration of a duty cycle may consider the number of terminal devices with suboptimal configurations for the duty cycles from among a number of terminal devices associated with a particular device 130. For example, the second condition may require that a frequency of a first number of duty cycles used by the device 130 for querying the first number of terminal devices among a second number of terminal devices associated with the device 130 is equal to or lower than a threshold frequency. In an example, a proportion of the terminal devices with the suboptimal configurations among the associated terminal devices may be equal to or greater than a threshold proportion. The threshold proportion may be set depending on the implementations. For example, if a device 130 is configured with 10 terminal devices 120 and only one of the ten terminal devices 120 has a suboptimal query configuration, then the network device 110 may decide not to reconfigure the device 130 to change the duty cycle for the terminal devices with the suboptimal configuration.

Alternatively, or in addition, the second condition may consider a number of connection losses reported by the device(s) 130, for example, the number of connection losses reported by a single device, a number of devices or a threshold number of devices. In an example, the second condition may be satisfied when the number of connection losses is equal to or greater than a threshold number. Thus, the reconfiguration can be triggered if the number of connection losses needing a reconfiguration is larger, for example, above the threshold number of connection losses.

In some cases, the devices 130 may be mobile, and each device 130 may be configured with a different duty cycle for querying different tags. In these cases, if one device 130 reports the tag as lost, a reconfiguration for all the terminal devices associated with that device may not be needed because other terminal devices may be able to be queried even though which may be at less frequency. If the devices which is prioritized for a terminal device keep declaring the terminal device as lost, then the duty cycles for queries of the remaining readers may be less than optimal, and hence a reconfiguration may be triggered. With such a second condition, the reconfiguration may be performed when the device(s) 130 has a number of terminal devices with suboptimal querying cycles, with no need to immediately configure a device(s) 130 after it reports a lost terminal device.

The use of the second condition for enabling a reconfiguration of a duty cycle may further reduce overhead for the reconfiguration of the duty cycles when a connection of a terminal device 120 to one or more devices 130 is lost.

Alternatively, or in addition, if the received measurement reports includes a report of a loss of a connection with a terminal device, the network device 110 may transmit, to the set of devices 130_1, 130_2, . . . , 130_N, a configuration for reconfiguring a power level threshold to be used for identifying a loss of a connection with the terminal device, and/or a power level to be used for transmissions of queries towards the terminal device. Alternatively, the network device 110 may initiate a reassociation procedure for the terminal device.

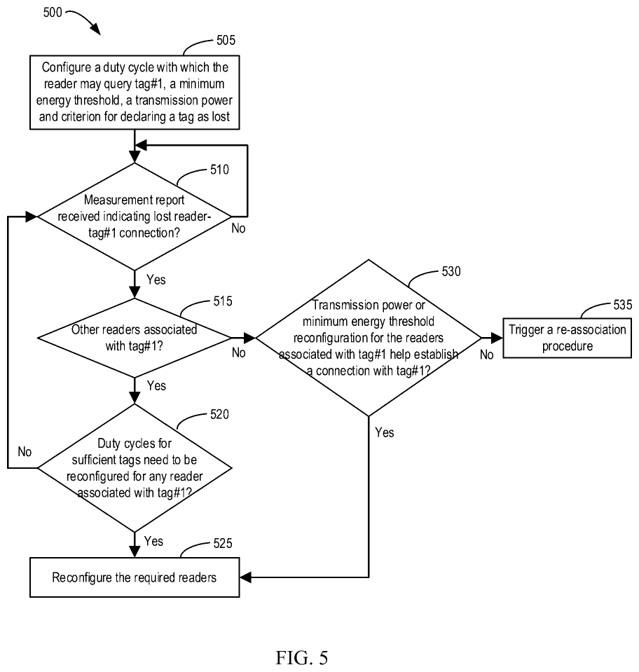

Some example operations of the network device 110 will be discussed below with reference to FIG. 5.

FIG. 5 shows a flowchart of an example process 500 at the network device 110 in accordance with some example embodiments of the present disclosure. In this example, a gNB may act as the network device 110, a reader may act as a device 130, and a tag may act a terminal device 120.

In the process 500, at 505, the network device 110 or the gNB may configure a duty cycle with which the reader may query a specific tag, labelled as tag #1, a minimum power threshold, a transmission power and criterion for declaring a tag as lost. For example, the gNB may configure each reader with a specific query cycle. For the tags associated with more than one reader, the query frequency of the readers may be configured based on SINR measurements of the signal backscattered from the tag, reported by the readers.

The gNB may wait for a measurement report from a reader in which a tag has been declared “missing” or “lost”. The measurement reports may be periodic and/or event based depending on the configuration the gNB provides to the reader. As shown in FIG. 5, at 510, the gNB may determine whether a measurement report received indicates a lost connection between the reader and tag #1. Upon the reception of such a report, at 515, the gNB may determine whether other readers are associated with tag #1. For example, the gNB may check whether this tag has been configured with a connection to any other reader.

If there are other readers are associated with tag #1, then at 520, the gNB may determine whether duty cycles for sufficient tags need to be reconfigured for any reader associated with tag #1. For example, for a reader associated with tag #1 and other tags, the gNB may determine whether duty cycles for a larger number of tags need to be reconfigured. If yes, at 525, the gNB may reconfigure the required readers. If no, the process 500 returns to 510 where the gNB may continue to monitor for a measurement report from a reader indicating a loss connection with a tag.

If it is determined at 515 that there are no other readers associated with the tag or with SINR measurements above a threshold, then at 530, the gNB may evaluate whether a transmission power or minimum power threshold reconfiguration for the readers associated with tag #1 may help establish a connection with tag #1, for example, by reconfiguring the minimum power thresholds and/or the transmission power set for a reader-tag pair, the connectivity between that tag and the reader may be re-established.

If yes, the process 500 may proceed to 525 where the gNB may reconfigure the required readers. For example, if the minimum power threshold to declare the lost tag or the maximum transmission power from the reader to the tag were set very conservatively, then this may be modified at this stage. Thus, if the received power or SINR reported from all readers for the tag is below a threshold, the gNB can try to reconfigure the readers with a lower minimum received power or SINR threshold and/or a higher transmission power.

If such reconfiguration may not be helpful, then at 535, the gNB may trigger a re-association procedure. Otherwise, the process 500 may proceed to 525 where the gNB may reconfigure the required readers. For example, if there is no possibility to re-establish the connectivity between the tag and a known reader, then the gNB may fall back to initiating a re-association procedure.

By allowing multiple readers to report SINR for a particular tag, the specific tag may be proactively reassociated with different readers without a loss of connectivity, which may enable tag and/or reader mobility. Moreover, the reassociation procedure has low complexity to allow robust communication for the backscattering devices such as tags in an environment where tag and/or reader may be mobile. Compared to a legacy re-association procedure, the proposed reassociation procedure may enable mobility of tags and/or readers with lower overhead.

In some example embodiments, the network device 110 may transmit, to the set of devices 130_1, 130_2, . . . , 130_N, a configuration for enabling queries of the plurality of terminal devices 120. Based on such a configuration, the devices 130 may trigger a query towards the terminal devices 120.

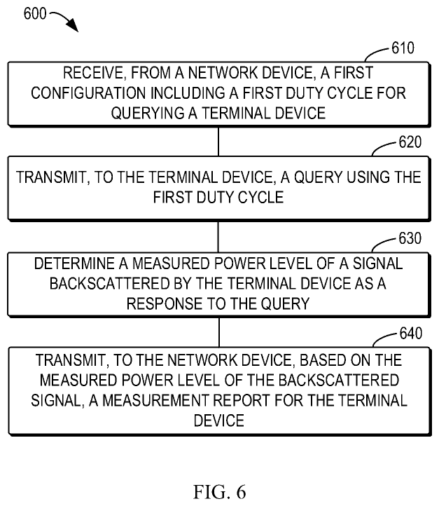

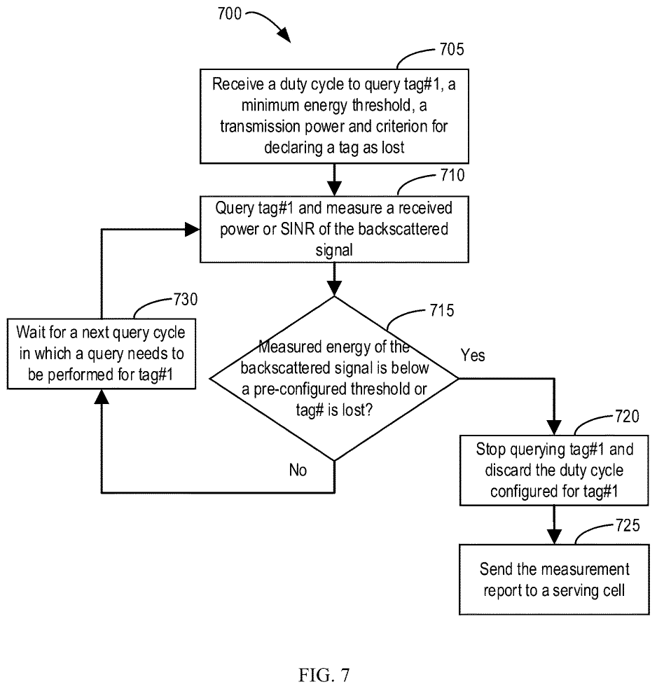

Example implementations at the device 130 will be discussed below with reference to FIGS. 6 and 7.

FIG. 6 shows a flowchart of an example method 600 for connectivity detection at the device 130 in accordance with some example embodiments of the present disclosure. For the purpose of discussion, the method 600 will be described from the perspective of the device 130 with reference to in FIG. 1.

At block 610, the device 130 receives, from the network device 110, a first configuration including a first duty cycle for querying a terminal device 120. At block 620, the device 130 transmits, to the terminal device 120, a query using the first duty cycle. As discussed above, the network device 110 may configure the device 130 to enable such a query. Based on this configuration, the device 130 may initiate queries for its associated terminal devices.

At block 630, the device 130 determines a measured power level of a signal backscattered by the terminal device 120 as a response to the query. For example, every time the device 130 queries the terminal device 120, the device 130 may measure the signal backscattered by the terminal device 120. At block 640, based on the measured power level of the backscattered signal, the device 130 transmits, to the network device 110, a measurement report for the terminal device 120.

The measurement report may be transmitted periodically or triggered by an event which may depend on the configuration provided by the network device 110 to the device. In some example embodiments, the measurement report may comprise an identification (ID) of the terminal device and a measured power level of a signal backscattered by the terminal device.

In some example embodiments, the device 130 may identify or evaluate whether the terminal device 120 is lost. If it is determined that the terminal device 120 is lost, the device 130 may transmit to the network device 110 a report of a loss of a connection with the terminal device 120.

In some example embodiments, the device 130 may receive, from the network device 110, a configuration including a first condition to be used for identifying a loss of a connection with the terminal device. Based this first condition, the device 130 may determine a lost terminal device. Alternatively, or in addition, a preconfigured or default criterion may be used by the device 130 to declare a lost terminal device.

In an example, the first condition may be based on a measured power level for the terminal device. For example, the first configuration may be satisfied when a measured power level of a first number of signals backscattered by the terminal device as a response to a second number of queries to the terminal device is less than or equal to a power level threshold.

In some example embodiments, the device 130 may receive, from the network device 110, a configuration including a threshold power level to be used for identifying a loss of a connection with the terminal device. In some example embodiments, the device 130 may receive, from the network device 110, a configuration including a power level to be used for transmissions of a query towards the terminal device 120. Accordingly, the device 130 may transmit the query to the terminal device 120 at the configured power level.

If the device 130 determines a loss of a connection with the terminal device 120, the device 130 may transmit, to the network device 110, a report of the loss of the connection with the terminal device 120. This report may also include the ID of the terminal device 120 and its latest measurements of the signal backscattered by the terminal device 120. In some example embodiments, the device 130 may discard the configurations related to the query of the terminal device 120, for example, the first configuration including the first duty cycle for the query of the terminal device. In some example embodiments, the device 130 may cease a query to the terminal device 120, and no longer query the terminal device 120. In this way, the device 130 may automatically drop the querying for the terminal device without a need for c-plane procedures.

FIG. 7 shows a flowchart of an example process 700 at the device 130 in accordance with some example embodiments of the present disclosure. In this example, a gNB may act as the network device 110, a reader may act as a device 130, and a tag may act a terminal device 120.

In the process 700, at 705, the device 130 or the reader may receive a duty cycle to query a tag, labelled as tag #1, a minimum power threshold, a transmission power and criterion for declaring a tag as lost. For example, the reader may be configured with a specific duty cycle which it can employ to query tag #1. In addition, the reader may be provided a minimum power threshold and a criterion to declare the tag as lost and the maximum allowed power level for transmissions towards a tag.

At 710, the reader may query tag #1 and measure a received power or SINR of the signal backscattered by tag #1. The reader may initiate queries for its associated tags as per the configuration provided at 705. At 715, the reader may determine whether a measured power of the backscattered signal is below a pre-configured threshold or tag #1 is lost. For example, every time the reader queries tag #1, it may measure the backscattered signal and evaluate if the tag is lost.

If the measured power of the backscattered signal is below a pre-configured threshold or tag #1 is lost, then at 720, the reader may stop querying tag #1 and discard the duty cycle configured for tag #1. In an example, if the reader declares that the tag is lost as per the configured criterion, it may discard the first configuration including the first duty cycle for the query of the terminal device.

At 725, the reader may send the measurement report to a serving cell of the gNB. The report may include a received power or SINR and/or information on missing or lost tag. In an example, if the reader declares that the tag is lost, it may send a measurement report to the gNB indicating that the tag is lost, which may possibly include that tag ID and its latest measurements of the signal backscattered by this tag. These measurements may be used by the gNB to e.g., fine tune the minimum configured power threshold or the maximum transmission power for the reader for a specific tag.

If it is determined at 715 that the measured power of the backscattered signal is above the pre-configured threshold, then at 730, the reader may wait for a next query cycle in which a query needs to be performed for tag #1. Then, the process 700 proceeds to 710 where the reader repeatedly query tag #1 and measure a received power or SINR of the signal backscattered by tag #1.

All operations and features related to the device 130 as described above with reference to FIGS. 1 to 5 are likewise applicable to the method 600 and the process 700 and have similar effects. For the purpose of simplification, the details will be omitted.

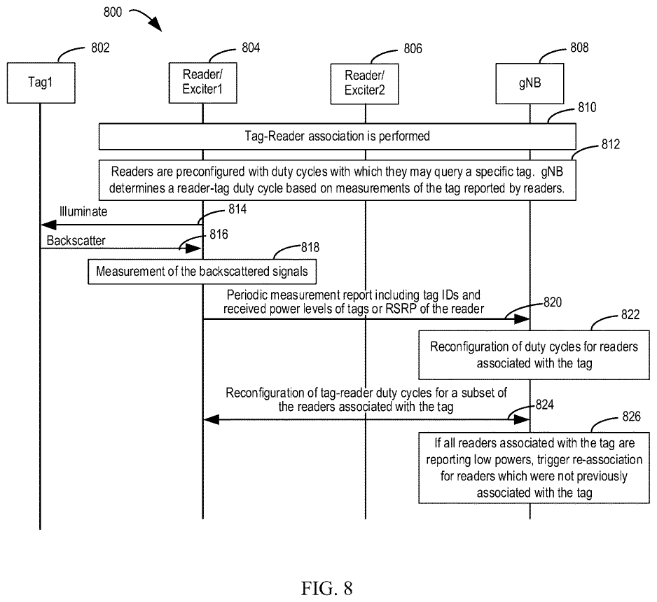

FIG. 8 shows a signaling diagram of a process 800 for connectivity detection and reassociation according to some example embodiments of the present disclosure. For the purpose of discussion, the process 800 will be described with reference to FIG. 1.

In this example, a tag 802, labelled as Tag1, may act as the terminal device 120, readers or exciters 804 and 806, labelled as Reader/Exciter1 and Reader/Exciter2 respectively, may act as the device 130, and the reader or exciter 804 is associated or connected with the tag 802. A gNB 808 may act as the network device 110.

As shown in FIG. 8, at 810, tag-reader association may be performed in any suitable association procedure. At 812, readers may be preconfigured with duty cycles with which they may query a specific tag, and the gNB 808 may determine a reader-tag duty cycle based on measurements of the tag reported by readers. At 814, the reader or exciter 804 may illuminate a signal to the tag 802. At 816, the tag 802 may backscatter a signal to the reader or exciter 804 as a response. At 818, the reader or exciter 804 may measure the backscattered signal. At 820, the reader or exciter 804 may transmit to the gNB 808 a periodic measurement report including tag IDs and received power levels of tags or RSRP of the reader.

In this example, Reader1 provides a measurement report to the gNB 808 declaring that Tag1 is lost. This may lead the gNB 808 to reconfigure Reader2's query cycle for Tag1 at 822. As shown in FIG. 8, at 824, the gNB 808 may initiate a reconfiguration of tag-reader duty cycles for a subset of the readers associated with the tag 802. At 826, if all readers associated with the tag are reporting low powers, the gNB 808 may trigger re-association for readers which were not previously associated with the tag 802.

For example, if reconfiguration of query cycles does not help improving SINR quality of the tag above a threshold, for example, there are no other readers reporting, for the tag 802, a measured SINR above a threshold, the gNB may either use the reported measurements of the backscattered signal to fine tune the minimum configured power threshold for a specific tag(s) or start a new association procedure.

In some example embodiments, an apparatus capable of performing any of the method 300 (for example, the network device 110 in FIG. 1 may comprise means for performing the respective operations of the method 300. The means may be implemented in any suitable form. For example, the means may be implemented in a circuitry or software module. The apparatus may be implemented as or included in the network device 110 in FIG. 1.

In some example embodiments, the apparatus comprises means for transmitting, to a set of devices, a first configuration including a first set of duty cycles for querying a plurality of terminal devices associated with the set of devices; and means for receiving, from the set of devices, a set of measurement reports for the plurality of terminal devices.

In some example embodiments, the apparatus comprises: means for transmitting, to a subset of the set of devices, a second configuration including a second set of duty cycles for querying the terminal devices.

In some example embodiments, the apparatus comprises: means for transmitting, to the set of devices, a configuration including a power level threshold to be used for identifying a loss of a connection with a terminal device of the plurality of terminal devices.

In some example embodiments, the apparatus comprises: means for transmitting, to the set of devices, a configuration including a set of power levels to be used for transmissions of queries towards the plurality of terminal devices.

In some example embodiments, the apparatus comprises: means for transmitting, to the set of devices, a configuration including a first condition to be used for identifying a loss of a connection with a terminal device of the plurality of terminal devices.

In some example embodiments, the first condition is satisfied when a measured power level of a first number of signals backscattered by the terminal device as a response to a second number of queries to the terminal device is less than or equal to a power level threshold.

In some example embodiments, the set of measurement reports comprises a report of a loss of a connection with a terminal device of the plurality of terminal devices.

In some example embodiments, the apparatus comprises: means for in response to receiving, from a device in the set of devices, the report of the loss of the connection with the terminal device, determining that at least one further device in the set of devices is associated with the terminal device; and means for transmitting, to the at least one further device, based on a second condition for enabling a reconfiguration of a duty cycle, a third configuration including at least one duty cycle for querying the terminal device.

In some example embodiments, the second condition is satisfied when a frequency of a first number of duty cycles used by the at least one further device for querying the first number of terminal devices among a second number of terminal devices associated with the at least one further device is equal to or lower than a threshold frequency.

In some example embodiments, the second condition is satisfied when a number of connection losses reported is equal to or greater than a threshold number.

In some example embodiments, the apparatus comprises: in response to the set of measurement reports including a report of a loss of a connection with a terminal device of the plurality of terminal devices: means for transmitting, to the set of devices, a configuration for reconfiguring one or more of a power level threshold to be used for identifying a loss of a connection with the terminal device, or a power level to be used for transmissions of queries towards the terminal device; or means for initiating a reassociation procedure for the terminal device.

In some example embodiments, the first set of duty cycles are configured to avoid more than one query transmitted to a terminal device of the plurality of terminal devices at a query occasion.

In some example embodiments, frequencies for querying a terminal device of the plurality of terminal devices are determined based on a proximity between the set of devices and the terminal device.

In some example embodiments, the apparatus comprises: means for determining the proximity between the set of devices and the terminal device based on a power level of signals measured by the set of devices for the terminal device.

In some example embodiments, a measurement report in the set of measurement reports comprises at least one identification of at least one terminal device of the plurality of terminal devices and at least one measured power level of a signal backscattered by the at least one terminal device.

In some example embodiments, a measurement report in the set of measurement reports is received by the network device periodically or triggered by an event.

In some example embodiments, the apparatus comprises: means for transmitting, to the set of devices, a configuration for enabling queries of the plurality of terminal devices.

In some example embodiments, the apparatus further comprises means for performing other operations in some example embodiments of the method 300 or the network device 110. In some example embodiments, the means comprises at least one processor; and at least one memory storing instructions that, when executed by the at least one processor, cause the performance of the apparatus.

In some example embodiments, an apparatus capable of performing any of the method 600 (for example, the device 130 in FIG. 1 may comprise means for performing the respective operations of the method 600. The means may be implemented in any suitable form. For example, the means may be implemented in a circuitry or software module. The apparatus may be implemented as or included in the device 130 in FIG. 1.

In some example embodiments, the apparatus comprises means for receiving, from a network device, a first configuration including a first duty cycle for querying a terminal device; means for transmitting, to the terminal device, a query using the first duty cycle; means for determining, a measured power level of a signal backscattered by the terminal device as a response to the query; and means for transmitting, to the network device, based on the measured power level of the backscattered signal, a measurement report for the terminal device.

In some example embodiments, the apparatus comprises: means for receiving, from the network device, a configuration including a threshold power level to be used for identifying a loss of a connection with the terminal device.

In some example embodiments, the apparatus comprises: means for receiving, from the network device, a configuration including a power level to be used for transmissions of a query towards the terminal device, wherein the query is transmitted to the terminal device based on this configuration.

In some example embodiments, the apparatus comprises: means for receiving, from the network device, a configuration including a first condition to be used for identifying a loss of a connection with the terminal device.

In some example embodiments, the first condition is satisfied when a measured power level of a first number of signals backscattered by the terminal device as a response to a second number of queries to the terminal device is less than or equal to a power level threshold.

In some example embodiments, the measurement report comprises an identification of the terminal device and a measured power level of a signal backscattered by the terminal device.

In some example embodiments, the measurement report is transmitted periodically or triggered by an event.

In some example embodiments, the apparatus comprises: means for receiving, from the network device, a configuration for enabling a query of the terminal device, wherein the query is transmitted based on this configuration.

In some example embodiments, the apparatus comprises: means for based on a determination a loss of a connection with the terminal device, transmitting, to the network device, a report of the loss of the connection with the terminal device.

In some example embodiments, the apparatus comprises: means for discarding the first configuration including the first duty cycle for the query of the terminal device.

In some example embodiments, the apparatus comprises: means for ceasing a query to the terminal device.

In some example embodiments, the apparatus further comprises means for performing other operations in some example embodiments of the method 600 or the device 130. In some example embodiments, the means comprises at least one processor; and at least one memory storing instructions that, when executed by the at least one processor, cause the performance of the apparatus.

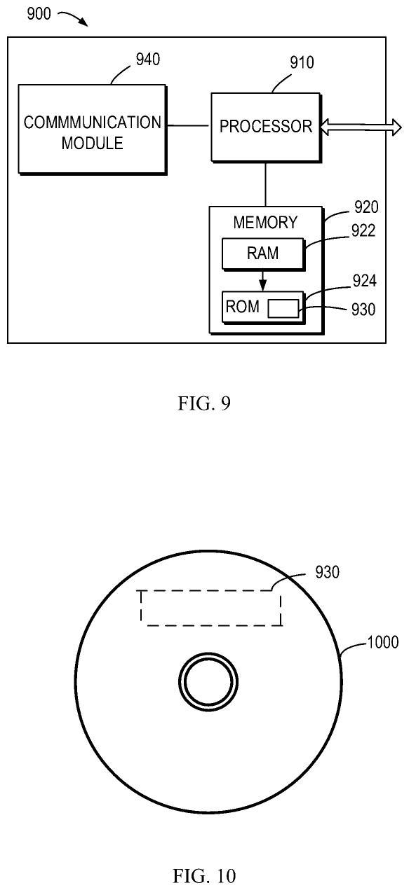

FIG. 9 is a simplified block diagram of a device 900 that is suitable for implementing example embodiments of the present disclosure. The device 900 may be provided to implement a communication device, for example, the network device 110 or the device 130 as shown in FIG. 1. As shown, the device 900 includes one or more processors 910, one or more memories 920 coupled to the processor 910, and one or more communication modules 940 coupled to the processor 910.

The communication module 940 is for bidirectional communications. The communication module 940 has one or more communication interfaces to facilitate communication with one or more other modules or devices. The communication interfaces may represent any interface that is necessary for communication with other network elements. In some example embodiments, the communication module 940 may include at least one antenna.

The processor 910 may be of any type suitable to the local technical network and may include one or more of the following: general purpose computers, special purpose computers, microprocessors, digital signal processors (DSPs) and processors based on multicore processor architecture, as non-limiting examples. The device 900 may have multiple processors, such as an application specific integrated circuit chip that is slaved in time to a clock which synchronizes the main processor.

The memory 920 may include one or more non-volatile memories and one or more volatile memories. Examples of the non-volatile memories include, but are not limited to, a Read Only Memory (ROM) 924, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 922 and other volatile memories that will not last in the power-down duration.

A computer program 930 includes computer executable instructions that are executed by the associated processor 910. The instructions of the program 930 may include instructions for performing operations/acts of some example embodiments of the present disclosure. The program 930 may be stored in the memory, e.g., the ROM 924. The processor 910 may perform any suitable actions and processing by loading the program 930 into the RAM 922.

The example embodiments of the present disclosure may be implemented by means of the program 930 so that the device 900 may perform any process of the disclosure as discussed with reference to FIG. 1 to FIG. 8. The example embodiments of the present disclosure may also be implemented by hardware or by a combination of software and hardware.

In some example embodiments, the program 930 may be tangibly contained in a computer readable medium which may be included in the device 900 (such as in the memory 920) or other storage devices that are accessible by the device 900. The device 900 may load the program 930 from the computer readable medium to the RAM 922 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 10 shows an example of the computer readable medium 1000 which may be in form of CD, DVD or other optical storage disk. The computer readable medium 1000 has the program 930 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-33. (canceled)

34. A network device comprising:
at least one processor; and
at least one memory storing instructions that, when executed by the at least one processor, cause the network device to:
transmit, to a set of devices each comprising a radio frequency identification (RFID) reader configured to illuminate and receive backscattered signals from battery-less terminal devices, a first configuration including:
a first set of duty cycles for querying a plurality of terminal devices, wherein each duty cycle is uniquely assigned per device-terminal device pair such that no two devices query the same terminal device at a same query occasion, and wherein frequencies of the duty cycles are determined based on measured signal-to-interference-plus-noise ratio (SINR) values of backscattered signals reported by the set of devices such that a device with a highest SINR for a terminal device is assigned a highest query frequency;
receive, from the set of devices, a set of measurement reports for the plurality of terminal devices, each measurement report including:
an identifier of a terminal device, and
a measured power level or SINR of a signal backscattered by the terminal device in response to a query;
determine, based on the received measurement reports, that a loss of connection with a first terminal device has occurred in response to a measured power level of at least X backscattered signals out of Y consecutive queries being less than or equal to a configured minimum power threshold; and
in response to the determination that the loss of connection has occurred:
determine that at least one additional device in the set of devices is associated with the first terminal device; and
transmit, to the at least one additional device, a second configuration including a modified duty cycle having an increased query frequency for the first terminal device.

35. The network device of claim 34, wherein the first set of duty cycles are configured such that duty cycles assigned to different devices for the same terminal device are temporally orthogonal to avoid overlapping query transmissions.

36. The network device of claim 35, wherein the frequencies of the duty cycles are inversely proportional to a ranking of the measured SINR values such that devices having lower SINR values are assigned lower query frequencies.

37. The network device of claim 36, wherein the first configuration further includes the configured minimum power threshold used for determining the loss of connection with the first terminal device.

38. The network device of claim 37, wherein the first configuration further includes a maximum transmission power level for queries transmitted by each device toward the plurality of terminal devices.

39. The network device of claim 38, wherein determining that the loss of connection has occurred further comprises determining that a ratio of the X backscattered signals to the Y consecutive queries does not satisfy a predefined loss criterion.

40. The network device of claim 39, wherein the measurement reports are received periodically according to a reporting configuration transmitted by the network device.

41. The network device of claim 40, wherein the measurement reports are received in response to an event indicating that the measured power level or SINR falls below the configured minimum power threshold.

42. The network device of claim 41, wherein transmitting the second configuration comprises increasing the query frequency of the at least one additional device relative to the first set of duty cycles based on a proximity of the at least one additional device to the first terminal device determined from the measurement reports.

43. The network device of claim 42, wherein the network device is further caused to, in response to determining that no additional device is associated with the first terminal device, initiate a reassociation procedure for the first terminal device with a different device.

44. A method performed by a network device, the method comprising:
transmitting, to a set of devices each comprising a radio frequency identification (RFID) reader configured to illuminate and receive backscattered signals from battery-less terminal devices, a first configuration including:
a first set of duty cycles for querying a plurality of terminal devices, wherein each duty cycle is uniquely assigned per device-terminal device pair such that no two devices query the same terminal device at a same query occasion, and wherein frequencies of the duty cycles are determined based on measured signal-to-interference-plus-noise ratio (SINR) values of backscattered signals reported by the set of devices such that a device with a highest SINR for a terminal device is assigned a highest query frequency;
receiving, from the set of devices, a set of measurement reports for the plurality of terminal devices, each measurement report including:
an identifier of a terminal device, and
a measured power level or SINR of a signal backscattered by the terminal device in response to a query;
determining, based on the received measurement reports, that a loss of connection with a first terminal device has occurred in response to a measured power level of at least X backscattered signals out of Y consecutive queries being less than or equal to a configured minimum power threshold; and
in response to the determination that the loss of connection has occurred:
determining that at least one additional device in the set of devices is associated with the first terminal device; and
transmitting, to the at least one additional device, a second configuration including a modified duty cycle having an increased query frequency for the first terminal device.

45. The method of claim 44, wherein the first set of duty cycles are configured such that, for the first terminal device, query occasions assigned to different devices are offset in time according to a predefined phase offset schedule.

46. The method of claim 45, wherein the frequencies of the duty cycles are selected from a discrete set of predefined query intervals, and the device having the highest SINR is assigned a shortest interval among the predefined query intervals.

47. The method of claim 46, wherein the measured SINR values used to determine the frequencies are averaged over a sliding window of a predetermined number of prior queries for each device-terminal device pair.

48. The method of claim 47, wherein the configured minimum power threshold is dynamically adjustable by the network device based on historical measurement reports associated with the first terminal device.

49. The method of claim 48, wherein X and Y are configurable parameters included in the first configuration and satisfy X<Y and X≥2.

50. The method of claim 49, wherein the second configuration further causes the at least one additional device to cease querying at least one other terminal device in order to accommodate the increased query frequency for the first terminal device.

51. The method of claim 50, wherein the at least one additional device is selected based on having a second-highest SINR for the first terminal device among the set of devices.

52. The method of claim 51, wherein the modified duty cycle is configured such that the increased query frequency is at least twice a previous query frequency assigned to the at least one additional device for the first terminal device.

53. The method of claim 52, further comprising: suppressing transmission of the second configuration unless a number of terminal devices experiencing loss of connection exceeds a predefined threshold.
